(19) United States
(12) Patent Application Publication
(10) Pub. No.: US 2026/0363358 A1
(43) Pub. Date: Nov. 19, 2026

(54) CHARGING APPARATUS FOR USE WITH A NON-COMBUSTIBLE AEROSOL PROVISION DEVICE

(71) Applicant: Nicoventures Trading Limited, London (GB)

(72) Inventors: Thomas LEAH, London (GB); Benjamin TAYLOR, London (GB); Luke WARREN, London (GB); Matthew HODGSON, London (GB); Tomi VINTOLA, London (GB); Jeremy CAMPBELL, London (GB)

(21) Appl. No.: 19/751,042

(22) Filed: Jul. 22, 2026

Related U.S. Application Data
(63) Continuation of application No. 18/041,914, filed on Aug. 17, 2021.

(30) Foreign Application Priority Data
Aug. 17, 2020 (GB) 2012842.7

(51) Int. Cl. A24F 40/95; H02J 7/34; H02J 7/50; H02J 7/70; H02J 7/82; H02J 7/90

(52) U.S. Cl. CPC A24F 40/95; H02J 7/342; H02J 7/50; H02J 7/751; H02J 7/82; H02J 7/933

(57) ABSTRACT

A charging apparatus is provided. The charging apparatus comprises a first power source; a first device for supplying electrical power to a non-combustible aerosol provision device; and a second device for receiving electrical power from an external power source. In a first mode of operation, the charging apparatus is arranged to supply electrical power to one or more aerosol generators of a non-combustible aerosol provision device.

### TECHNICAL FIELD

The present invention relates to a charging apparatus for use with a non-combustible aerosol provision device.

### Background

Attempts have been made to provide alternatives to smoking articles such as cigarettes, cigars and the like that burn tobacco during use to create tobacco smoke. Some examples are devices which generate a tobacco flavoured aerosols/vapours and/or flavour infused air. Most of these devices include an internal battery to supply energy to various components of the devices, such as heating arrangements and control circuitry. The increased functionalities of these devices are becoming more demanding on the internal battery.

### Summary

According to an aspect of the present invention, there is provided a charging apparatus comprising:
a first power source;
a first device for supplying electrical power to a non-combustible aerosol provision device; and
a second device for receiving electrical power from an external power source;
wherein in a first mode of operation the charging apparatus is arranged to supply electrical power to one or more aerosol generators of a non-combustible aerosol provision device.

The charging apparatus is preferably portable. According to an embodiment the charging apparatus comprises a portable charging apparatus.

According to an embodiment in the first mode of operation the first power source is arranged to supply electrical power to the one or more aerosol generators of the non-combustible aerosol provision device. It is contemplated that according to various embodiments in the first mode of operation the non-combustible aerosol provision device receives power from the battery of a portable charging case rather than from an external power source during use.

Embodiments are contemplated wherein the non-combustible aerosol provision device receives power from the battery of a charging case (or another portable electronic device such as a mobile phone or smartphone) via a wired or wireless connection. Less preferred embodiments are contemplated wherein the non-combustible aerosol provision device receives power from an external power source e.g. mains via a wireless connection.

In the first mode of operation the charging apparatus may be arranged to supply electrical power to one or more aerosol generators of a non-combustible aerosol provision device so that the one or more aerosol generators generate aerosol from one or more aerosol-former materials.

The first device may be arranged to supply electrical power to the non-combustible aerosol provision device via either: (i) a wired connection; and/or (ii) a wireless connection.

The second device may be arranged to receive electrical power from an external power source via either: (i) a wired connection; and/or (ii) a wireless connection.

The charging apparatus and/or a non-combustible aerosol provision device may be arranged to detect that the non-combustible aerosol provision device may be mechanically coupled to, held within or may be otherwise inserted into or within the charging apparatus.

The charging apparatus and/or a non-combustible aerosol provision device may be arranged to detect that a non-combustible aerosol provision device is electrically coupled to the charging apparatus.

The charging apparatus may further comprise a third device for receiving a signal from a non-combustible aerosol provision device that the non-combustible aerosol provision device is either: (i) mechanically coupled to, held within or is otherwise inserted into or within the charging apparatus; and/or (ii) is electrically coupled to the charging apparatus.

In a second mode of operation the charging device may be arranged to supply electrical power to a second power source housed within a non-combustible aerosol provision device. The second power source may comprise a rechargeable battery.

In the first mode of operation the charging device may be further arranged to supply electrical power to the first power source and/or to a second power source housed within a non-combustible aerosol provision device. In the first mode of operation, the charging device may be arranged to simultaneously supply electrical power to one or more aerosol generators of a non-combustible aerosol provision device, while also supplying electrical power to the first power source and/or to a second power source housed within the non-combustible aerosol provision device.

In a mode of operation electrical power may be diverted from supplying electrical power to the one or more aerosol generators in order to supply electrical power to either recharge the first power source and/or to recharge a second power source housed within a non-combustible aerosol provision device.

Preferably, one or more indicators may be arranged to indicate the charge status of the first rechargeable battery and/or a second power source housed within a non-combustible aerosol provision device.

The one or more indicators preferably comprise one or more light emitting diodes.

The charging apparatus preferably comprises a portable carry case for storing the non-combustible aerosol provision device.

According to another aspect there is provided a system comprising:
a charging apparatus as discussed above; and
a non-combustible aerosol provision device.

The non-combustible aerosol provision device may be mechanically coupled and/or electrically coupled to the charging apparatus in use.

The system may further comprise one or more aerosol-former materials, wherein optionally the one or more aerosol-former materials are inserted or otherwise retained, in use, within the non-combustible aerosol provision device.

According to another aspect there is provided a method comprising:
providing a charging apparatus coupled to a non-combustible aerosol provision device comprising one or more aerosol generators; and
supplying electrical power from the charging apparatus to the one or more aerosol generators.

According to the preferred embodiment at substantially the same time that electrical power is supplied from the charging apparatus to the one or more aerosol generators, the one or more aerosol generators preferably generate an aerosol.

It will be apparent, therefore, that a preferred feature of the present invention is the provision of a non-combustible aerosol provision device such as a tobacco heating product device wherein the device may be charged and operated in real time by power being supplied from a carry case or charging case.

Conventionally, before of a non-combustible aerosol provision device can be operated to generate an aerosol it must first be charged. However, according to various embodiments of the present invention the non-combustible aerosol provision device may be operated without delay by being powered via an associated charging case.

According to another aspect there is provided apparatus comprising:
a charging apparatus and/or a non-combustible aerosol provision device;
wherein either the charging apparatus and/or the non-combustible aerosol provision device further comprises a securing or retaining feature which secures or retains the non-combustible aerosol provision device to the charging apparatus.

The securing or retaining feature may comprise one or more magnets, magnetic or ferrous materials.

The charging apparatus may comprise one or more magnets, magnetic or ferrous materials.

The non-combustible aerosol provision device may comprise one or more magnets, magnetic or ferrous materials.

Embodiments are contemplated wherein e.g. the charging apparatus comprises one or more magnets and a portion of the non-combustible aerosol provision device comprises one or more magnets, magnetic or ferrous materials which are attracted magnetically to the one of more magnets in the charging apparatus.

Embodiments are also contemplated wherein a portion of the non-combustible aerosol provision device comprises one or more magnets and the charging apparatus comprises one or more magnets, magnetic or ferrous materials which are attracted magnetically to the one of more magnets in the non-combustible aerosol provision device.

The charging apparatus may comprise a portable carry case for storing the non-combustible aerosol provision device.

The apparatus may further comprise one or more aerosol-former or aerosol-generating materials, wherein optionally the one or more aerosol-former or aerosol-generating materials are inserted or otherwise retained, in use, within the non-combustible aerosol provision device.

As used herein, the term aerosol-former or aerosol-generating material is a material that is capable of generating aerosol, for example when heated, irradiated or energized in any other way. Aerosol-former or aerosol-generating material may, for example, be in the form of a solid, liquid or gel which may or may not contain an active substance and/or flavourants. In some embodiments, the aerosol-former or aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50wt%, 60wt% or 70wt% of amorphous solid, to about 90wt%, 95wt% or 100wt% of amorphous solid. The aerosol-generating material may comprise one or more active substances and/or flavours, one or more aerosol-former materials, and optionally one or more other functional material.

According to another aspect there is provided a system comprising:
a charging apparatus; and
a non-combustible aerosol provision device;
wherein either the charging apparatus and/or the non-combustible aerosol provision device further comprise a securing or retaining feature which secures or retains the non-combustible aerosol provision device to the charging apparatus.

The securing or retaining feature may comprise one or more magnets, magnetic or ferrous materials.

According to another aspect there is provided a method comprising:
providing a charging apparatus and a non-combustible aerosol provision device; and
securing or retaining the non-combustible aerosol provision device to the charging apparatus.

The step of securing or retaining the non-combustible aerosol provision device to the charging apparatus may further comprise securing or retaining the non-combustible aerosol provision device to the charging apparatus using one or more magnets.

However, the use of magnets to secure the non-combustible aerosol provision device to the charging apparatus is not essential and other embodiments are contemplated wherein, for example, a latching mechanism may be used to secure the non-combustible aerosol provision device to the charging apparatus.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic diagram of a non-combustible aerosol provision device;

FIG. 2 shows a schematic diagram of a charging apparatus connected the non-combustible aerosol provision device;

FIG. 3 shows a schematic diagram of a charging apparatus connected to an external power source;

FIG. 4 shows a schematic diagram of a charging apparatus connected to a non-combustible aerosol provision device and an external power source;

FIG. 5 shows a schematic diagram of the charging apparatus in more detail;

FIG. 6 shows a schematic diagram of a charging apparatus according to a second example;

FIG. 7 shows a schematic diagram of a non-power source device;

FIG. 8 shows a circuit diagram of a charging case connected to an aerosol generating device;

FIG. 9 shows a charging case and non-combustible aerosol provision device which is inserted or held within the charging case according to various embodiments; and

FIG. 10A shows and non-combustible aerosol provision device according to an embodiment and FIG. 10B shows an non-combustible aerosol provision device according to an embodiment.

### DETAILED DESCRIPTION

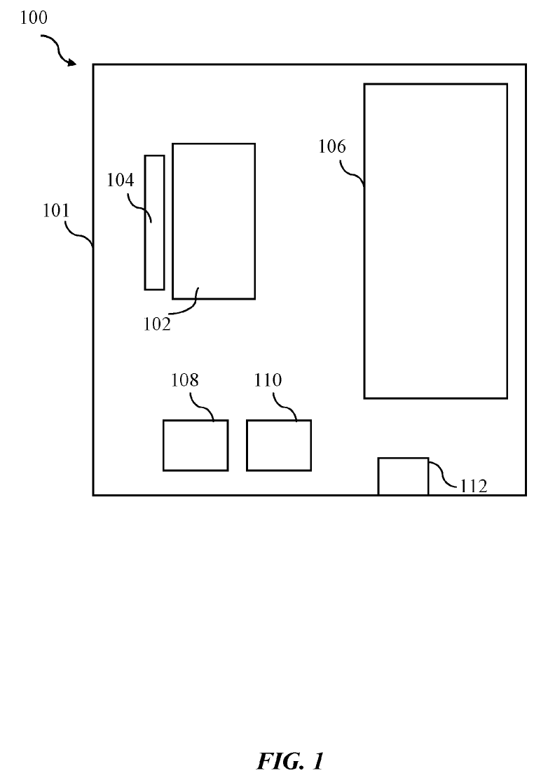

FIG. 1 is a simplified schematic view of a non-combustible aerosol provision device 100.

According to the present disclosure, a “non-combustible” aerosol provision device is one where an aerosol-generating material is not combusted or burned in order to facilitate delivery of at least one substance to a user. In other words, the non-combustible aerosol provision device provides an aerosol without burning or combusting the aerosol-former or aerosol-generating material.

In some examples, the non-combustible aerosol provision device is an electronic cigarette, also known as a vaping device or electronic nicotine delivery system (END), although it is noted that the presence of nicotine in the aerosol-generating material is not a requirement. In such examples, the non-combustible aerosol provision device vaporises an aerosol-former or aerosol-generating material in the form of a liquid.

In some examples, the non-combustible aerosol provision device is an aerosol-generating material heating device, also known as a heat-not-burn device, tobacco heating device, etc., as described above. In such examples, the aerosol generating material may not be in liquid form.

In some examples, the non-combustible aerosol provision device is a hybrid device to generate aerosol using a combination of aerosol-generating materials. In some such examples, one or a plurality of the aerosol-generating materials may be heated. Each of the aerosol-generating materials may be, for example, in the form of a solid, liquid, wax or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

The non-combustible aerosol provision device 100 comprises a housing 101 that houses the various components of the non-combustible aerosol provision device 100.

The non-combustible aerosol provision device 100 comprises a chamber 102 configured to receive or contain aerosol generating material (not shown). The aerosol generating material may be comprised in a consumable (not shown).

As used herein, the term aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50wt%, 60wt% or 70wt% of amorphous solid, to about 90wt%, 95wt% or 100wt% of amorphous solid. The aerosol-generating material may comprise one or more active substances and/or flavours, one or more aerosol-former materials, and optionally one or more other functional material.

The aerosol-former or aerosol-generating material may, for example, include one or more of tobacco, tobacco derivatives, expanded tobacco, reconstituted tobacco or tobacco substitutes. The aerosol-generating material may, for example, be a combination or a blend of materials. The aerosol-generating material may comprise one or more active substances and/or flavours, one or more aerosol-former materials, and optionally one or more other functional material. Aerosol-generating material may also be known as “smokable material”.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some examples, the active substance comprises nicotine. In some examples, the active substance comprises caffeine, melatonin or vitamin B12.

The aerosol-former material may comprise one or more constituents capable of forming an aerosol. In some examples, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

As used herein, a consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

The non-combustible aerosol provision device 100 comprises an aerosol generator 104 to volatilise at least one component of the aerosolizable material. The non-combustible aerosol provision device 100 is hereafter referred to as the device 100.

As used herein, an aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In examples in which the aerosol generator 104 is a heater, it may be a resistive heater or an inductive heater, for example. Where an inductive heater is used, the inductive heater generates a varying magnetic field in order to heat one or more susceptor elements. The one or more susceptor elements may or may not form part of the aerosol generator 104 in such examples.

A susceptor material is a material that can be heated by penetration with a varying magnetic field, such as an alternating magnetic field. The susceptor material may be an electrically conductive material, so that penetration thereof with a varying magnetic field causes induction heating of the heating material. The susceptor material may be magnetic material, so that penetration thereof with a varying magnetic field causes magnetic hysteresis heating of the susceptor material. The susceptor may be both electrically conductive and magnetic, so that the susceptor can be heated by both heating mechanisms.

The device 100 comprises a power source 106 located within the housing 101. The power source 106 supplies electrical power to the various components of the device 100 including the aerosol generator 104. The power source 106 may comprise a rechargeable battery, for example, a lithium ion battery. The rechargeable battery 106 may comprise a plurality of sub-batteries. In the following examples, the power source 106 is referred to simply as the battery 106. Alternatively, the power source 106 may comprise a capacitive charging device.

In the example of FIG. 1, the device 100 comprises control circuitry 108 which is in data communication with a computer readable storage memory 110. The control circuitry 108 is arranged to control the various aspects and operations of the device 100. For example, the control circuitry 108 may control the delivery of electrical power from the battery 106 to the aerosol generator 104. In some examples, the control circuitry 108 comprises a micro-processor or the like and associated circuitry for controlling the functions of the device 100.

In the example of FIG. 1, the device 100 comprises an electrical connection port 112 that is in electrical communication with the control circuitry 108 and the battery 106. Amongst other functions, the electrical connection port 112 facilitates charging of the battery 106 from an external power source (not shown), for example a battery charger or mains supply. In some examples the electrical connection port 112 is an industry standard electrical connection port such as Universal Serial Bus (USB), USB Type C, Micro USB and in other examples the electrical connection port 112 is a proprietary or bespoke connector arrangement. The electrical connection port 112 may also take the form of a wireless receiver so as to permit wireless charging of the battery 106.

It will be appreciated that the device 100 comprises other components not shown in FIG. 1, such as ventilation inlets/outlet, and a control interface. It should be noted that FIG. 1 is merely a schematic sketch showing a number of components that could be included in the device 100. FIG. 1 is not intended to communicate particular positions of various components.

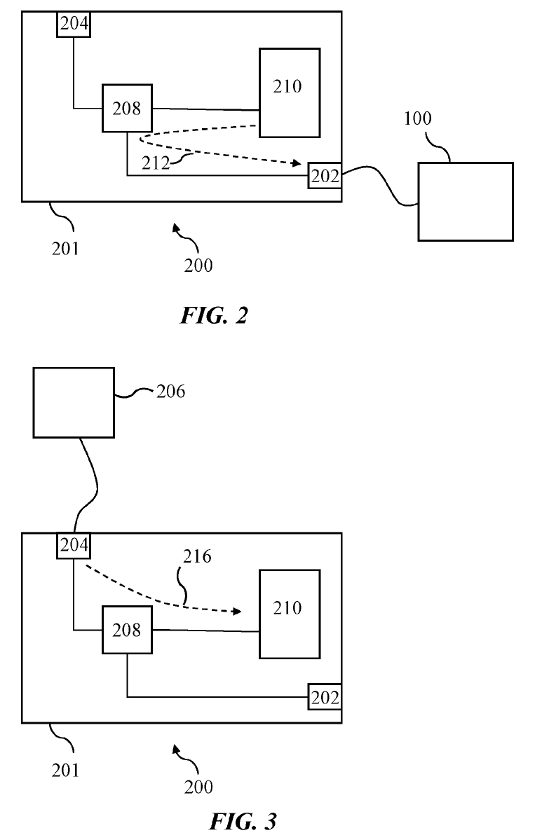

FIGS. 2-4 are simplified schematic diagrams of a charging device 200 with various combinations of devices connected thereto according to a first example. The charging device 200 comprises a housing 201 which contains and protects the various components of the charging device 200 including an internal battery 210. The internal battery 210 is a rechargeable battery, for example, a lithium ion battery. The internal battery 210 may comprise a plurality of sub-batteries.

As will be explained in more detail below, the charging device 200 is connectable to the device 100 in order for the charging device 200 device to provide power to charge the battery 106 of the device 100. When the device 100 is connected to the power provision device 200 and the charging device 200 is not itself connected to an external power supply (e.g. a mains supply), power to recharge the battery 106 of the device 100 is provided from the internal battery 210 of the charging device 200.

The charging device 200 is also connectable to an external power supply 206, for example, a mains supply. When the charging device 200 is connected to the external power supply 206 and the charging device 200 is not also connected to the device 100, the external power supply supplies power to charge the internal battery 210 of the charging device 200 when the internal battery 210 requires recharging.

The charging device 200 is configured so that when the charging device 200 is connected to the external power supply 206 and to the device 100, the charging device 200 prioritises directing power from the external power supply 206 to charge the battery 106 of the device 100 over directing power from the external power supply 206 to charge the internal battery 210 of the power provision device 200.

In this example, the charging device 200 is in the form of a portable carry case that can be used to store and charge the device 100 while a user of the device 100 is on the move. In effect, this extends the battery life of the device 100 without increasing the size/weight of the device 100 because a user can simply remove the device 100 from the carry case for use. Herein below, the charging device 200 will be referred to as the charging case 200.

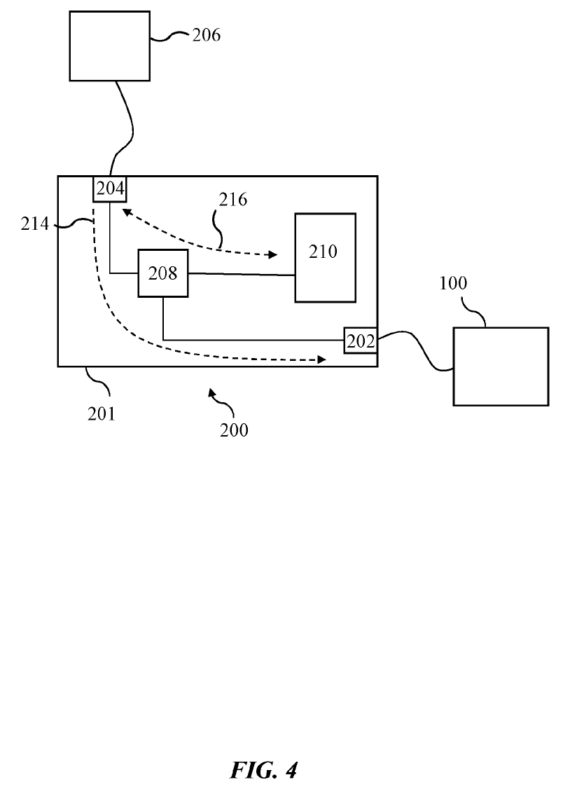

The charging case 200, as is best illustrated in FIGS. 2 and 4, comprises a first connection port 202 for connecting to the connection port 112 of the device 100. The connection may be a direct port to port connection, via a suitably arranged connecting cable or a wireless connection. In some examples, the first connection port 202 is a bespoke (i.e. proprietary) connection port. For example, the first connection port 202 may comprise two pins (e.g. ground and +5V). The advantage of a bespoke connection port 202 is that it permits only certain compatible devices with a corresponding bespoke connection port to removably connect to the charging case 200. For example, only other proprietary devices made by the manufacturer of the charging case 200.

The charging case 200 is arranged so that electrical power can be transferred from or via the charging case 200 through the first connection port 202 to the device 100. The electrical power transferred out of the charging case 200 charges the battery 106 of the device 100.

As is illustrated in FIGS. 3 and 4, the charging case 200 comprises a second connection port 204 for connecting to the external power source 206. Again, the connection may be a direct port to port connection, via a suitably arranged connecting cable or a wireless connection. The second connection port 204 is disposed within the housing 201 of the charging case 200 and provides a second electrical and/or data connection to the charging case 200. In this example, the second connection port 204 is an industry standard electrical connection port, for example, a USB connection port. This allows many different devices types of power sources and/or different types of other devices to be removably connected to the charging case 200. Of course, other examples of bespoke electrical connection sockets or power transfer arrangements could be used.

In some examples, the external power source 206 connects to a source of mains electricity via a wall socket to supply power via a cable that is connected to the second connection port 204. For example, such a power source could be a charger supplied with the charging case 200 or another generic USB charger connected to mains. In alternative examples, the external power source 206 is a power source from another device, for example, a computer, a car (via a car’s power outlet socket), solar panel, or the like connected via a cable or wirelessly to the second connection port 204.

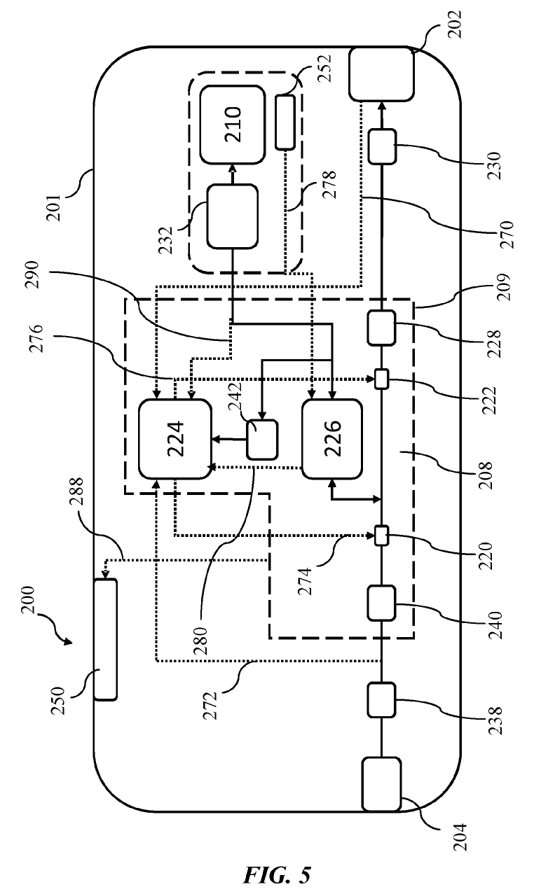

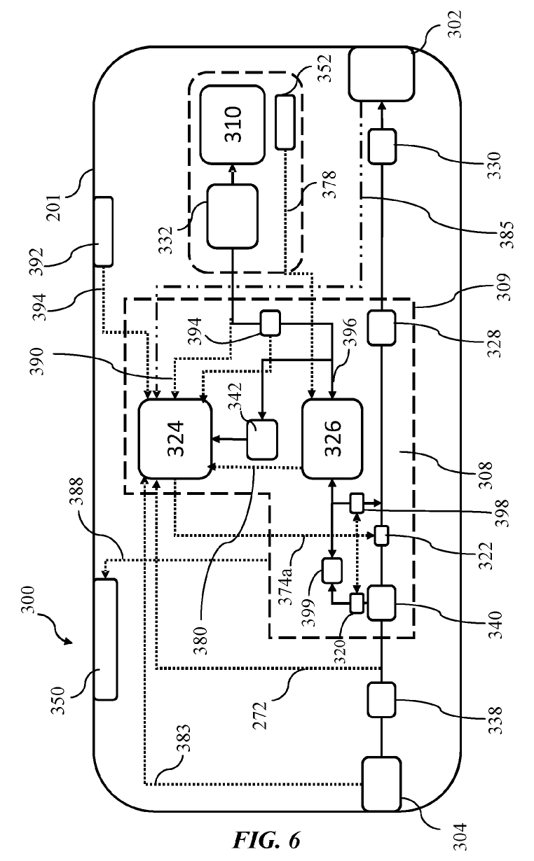

The second connection port 204 is in electrical connection with the first connection port 202 through control circuitry 208. Thus, electrical power supplied from the external power source 206 is transferred via the second connection port 204, the control circuitry 208 and the first connection port 202 to the device 100 as represented by arrow 214 in FIG. 4. Examples of control circuitry 208 are described below in more detail in relation to FIGS. 5 and 6.

The internal battery 210 of the charging case 200 stores electrical power provided from the external power source 206 and is arranged to provide a number of full charges, for example, at least two, to the device 100. The internal battery 210 is in electrical connection to the first connection port 202 and second connection port 204 through the control circuitry 208. The internal battery 210 is chargeable by the external power source 206 when the external power source 206 is connected to the second connection port 204.

As previously mentioned above, the flow of electrical power from the external power source 206 to the internal battery 210 and the device 100 is controlled by the control circuitry 208. In the example of FIG. 2, only the device 100 is connected to the charging case 200, and so electrical power is directed from the internal battery 210 through the first connection port 202 to the device 100 (shown by arrow 212) when the battery 106 of the device 100 requires charging.

In the example of FIG. 3, only the external power source 206 is connected to the charging case 200. Therefore, the control circuitry 208 directs electrical power from the external power source 206 to charge the internal battery 210 (shown by arrow 216) when the internal battery 210 requires charging.

When both the external power source 206 and the device 100 are connected to the charging case 200 (as best seen in FIG. 4) and both the battery 106 of the device 100 and the internal battery 210 of the charging case 200 require charging, the control circuitry 208 prioritises directing power from the external power source 206 to charge the battery 106 of the device 100 over directing power from the external power source 206 to charge the internal battery 210.

In one example, while the battery 106 of the device 100 is being charged, only if sufficient excess electrical power is available from the external power source 206, will the control circuitry 208 also supply power from the external power source 206 power to charge the internal battery 210 of the charging case 200.

In another example, when the battery 106 of the device 100 becomes fully charged, the control circuitry 208 only then starts to supply electrical power from the external power source 206 to charge the internal battery 210 of the charging case 200.

It will be appreciated that the charging case 200 may comprise other components not shown in FIGS. 2-4, such input detectors, charge status indicators, and switches. Moreover, the control unit 208 may comprise other components such as processors, sensors, and voltage regulating circuits. It should be noted that FIGS. 2-4 are merely schematic drawings showing a number of components that could be included in the charging case 200 or connected thereto. FIGS. 2-4 are not intended to communicate particular positions of various components.

FIG. 5 is a schematic diagram showing the charging case 200 as described in relation to FIGS. 2-4 in more detail. In FIG. 5, the solid arrows represent electrical power lines and dashed arrows represent control and/or monitoring lines between various internal components of the charging case 200. As previously described, the charging case 200 comprises a first connection port 202, a second connection port 204, control circuitry 208 (indicated in FIG. 5 as a dashed box) and an internal battery 210.

In this example, the charging case 200 further comprises a first electro-static discharge protection unit 230 and a second electro-static discharge protection unit 238. The first electro-static discharge unit 230 protects the first connection port 202 from electrostatic discharge and is situated between the first connection port 202 and the control circuitry 208. The second electro-static discharge unit 238 protects the second connection port 204 from electrostatic discharge and is situated between the second connection port 204 and the control circuitry 208. The charging case 200 also comprises one or more indicators 250 to indicate the charge status of the internal battery 210 and/or other information to a user of the charging case 200.

In some examples, the one or more indicators 250 are a set of light emitting diodes (LED) which are in electrical connection with the control circuitry 208 via a control line 288. The LEDs are used to indicate the charge status of the internal battery 210, for example, whether the internal battery 210 is fully charged, partially charged, or fully discharged. In one example, one or more indicators 250 comprise a single RGB LED where the different colours indicate different states of charge of the internal battery 210. In another example, the one or more indicators 250 comprise a plurality of single colour LEDs, for example, white LEDs, where the number of LEDs switched on are an indication of the charge status of the internal battery 210. In another example, the one or more indicators 250 indicate that the internal battery 210 is being charged in addition to indicating the charge status. Of course, other indicators such as screens, LCD displays, speakers and the like can equally well be used as to indicate the charge status of the charging case 200.

In this example, the control circuitry 208 is represented by the dashed box 209 which encompasses various components. The control circuitry 208 comprises a micro controller unit (MCU) 224 (for example a model STM32G031G4). The MCU 224 monitors the first connection port 202 via monitoring line 270 and the second connection port 204 via monitoring line 272 to detect if any devices are connected to the charging case 200 and that the first connection port 202 and second connection port 204 are active. Different external power sources supply different voltage levels and the MCU 224 monitors the voltage level on the monitoring line 272 of a power source or device connected to the second connection port 204. The voltage of the internal battery 210 is monitored by the MCU 224 over the monitoring line 290.

The control circuitry 208 further comprises an input voltage protection unit 240 to protect the internal components of the charging case 200 from over voltage and/or reverse voltage conditions. In one example, the charging case 200 can handle a +20V supply from USB type C power sources without damaging the internal components and the input protection unit 240 protects the charging case 200 when non-compliant USB type C chargers are connected. The control circuitry 208 further comprises an output voltage protection unit 228 to protect components of the device 100 when connected to the first connection port 203 from over current conditions.

The control circuitry 208 further comprises a low dropout voltage regulator (LDO) 242 to maintain a constant voltage supply.

The control circuitry 208 further comprises a charging integrated circuit 226 (charging IC). The charging IC 226, under the control of the MCU 224, regulates the charging of the internal battery 110 when a power supply is connected to the second connection port 204 and the internal battery 210 is being charged. The charging IC 226, under the control of the MCU 224, also regulates the charging of the battery 106 of the device 100 when the device 100 is connected to the first connection port 202 and is being charged from the internal battery 210. The charging IC 226 is in connection with the MCU 224 via a suitable control line 280, for example, a 12C link.

The charging IC 226 monitors the temperature of the internal battery 210 via a battery temperature monitor line 278 which is connected to a battery temperature sensor 252. The internal battery 210 is protected from overcharging by a battery protection unit 232. In one example, the battery temperature sensor 252 is in thermal contact with the internal battery 210 to provide an accurate temperature reading of the internal battery 210. For example, if while the internal battery 210 is charging, the temperature begins to reach a temperature that is deemed too hot for the internal battery 210, the charging IC 226 will reduce the current supply to the internal battery 210 accordingly. Alternatively, if while the internal battery is 210 is being used to charge the battery 106 of the device 100 that is connected to the first electrical connection port 202, the internal battery 210 temperature is deemed too high, the charging IC 226 reduces the current accordingly, or stops the charging to prevent damage to the internal battery 210. The charging IC 226 may also regulate the supply of electrical power to and from the internal battery 210 if the temperature of the internal battery 210 is too cold or below a certain threshold temperature.

The control circuitry 208 further comprises a first switch 220 and a second switch 222. The MCU 224 controls the first switch 220 via a first switch control line 274 and controls the second switch 222 via a second switch control line 276. As will be explained in more detail below, the MCU 224 directs electrical power between the first connection port 202, the second connection port 204 and the internal battery 210, by controlling the first switch 220 and second switch 222 to either ON or OFF states in various combinations. In one example, the first switch 220 and the second switch 222 are low ohmic Field Effect Transistors (FETs) although other types of switches may also be used.

The operation of the charging case 200, in relation to the configurations shown in FIGS. 2-4 and with reference to the components described in FIG. 5, is further described below.

In one example, as shown in FIG. 2, only the device 100 is connected to the charging case 200 and the battery 106 of the device 100 is under charged. In this scenario, the MCU 224 detects via the monitoring line 272 that the device 100 is connected to the charging case 200 through the first connection port 202 and determines via the monitoring line 270 that no power supply or further device is connected to the charging case 200 through the second connection port 204. The MCU 224 configures the first switch 220 via the switch control line 274 to be in an OFF state and the second switch 222 via the switch control line 276 to be in an ON state. Thus, with the switches in this configuration, electrical power is provided from the internal battery 210, via the charging IC 226 and the first connection port 202, to charge the battery 106 of the device 100. No electrical power can flow to the second connection port 204.

As described above, the charging IC 226 monitors the temperature of the internal battery 210 and adjusts the output voltage to the first connection port 202 to prevent the internal battery 210 from overheating and becoming damaged and/or a safety hazard to the user.

In another example, as shown in FIG. 3, only an external power source 206, is connected to the charging device 200 via the second connection port 204 and the internal battery 210 is under charged. In this configuration, the MCU 224 detects via the monitoring line 270 that the external power source 206 is connected to the second connection port 204 and determines from the monitoring line 272 that the device 100 is not connected to the charging case 200 through the first connection port 202. The MCU 224 configures the first switch 220 to be in an ON state and the second switch 222 to be in an OFF state via the switch control lines 274 and 276 respectively. When the first switch 220 and second switch 222 are in this configuration and the internal battery is under charged, electrical power from the external power source 206 is provided via the charging IC 226 to the internal battery 210 to charge the internal battery 210. The internal battery 210 is protected from overcharging by the battery protection unit 232 and the temperature of the battery is monitored during charging by the temperature sensor 252. No electrical power can flow to the first connection port 202.

In another example, as shown in FIG. 4, the device 100 and the external power source 106 are both connected to the charging case 200 via the first connection port 202 and the second connection port 204 respectively. The MCU 224 detects that the device 100 is connected to the first connection port 202 via the monitoring line 272 and that the external power source 106 is connected to the second connection port 204 via the monitoring line 270. Electrical power from the external power source 206 can be provided to the internal battery 210 or the battery 106 of the device 100 or both.

The MCU 224 prioritises charging the battery 106 of the device 100 over charging the internal battery 210 of the charging case 200.

In one example, the MCU 224 determines that the battery 106 of the device 100 is under charged and that the internal battery 210 is under charged but that the power available from the external power source 106 is sufficient only to meet the charging requirements of the battery 106 of the device 100. For example, the battery 106 of the device 100 may require a certain minimum supply voltage, e.g. 5V, for charging and the power source 106 can supply 5V. In this scenario, the MCU 224 configures the first switch 220 and second switch 222 to both be in an ON state via switch control lines 274 and 276 respectively and the charging IC 226, under the control of the MCU 224, prevents power from being provided from the power source 206 to the internal battery 210. Accordingly, in this scenario, electrical power is provided from the external power source 206 through a path defined by the second connection port 204, the first switch 220, second switch 222 and first connection port 202 to the device 100 and charges the battery 106 of the device 100.

The MCU 224 monitors the charge status of the battery 106 of the device 100 to determine when the battery 106 of the device 100 reaches a predetermined charge level, for example, fully charged and no longer requires electrical power to be supplied to it. In response to this determination being made, the MCU 224 configures the second switch 222 into an OFF state while maintaining the first switch 220 in the ON state, and the charging IC 226, under the control of the MCU 224, now enables power to be provided from the power source 106 to the internal battery 210. The voltage of the internal battery 210 is monitored by the MCU 224 over the monitoring line 290.

The prioritised charging of the battery 106 of the device 100 over the internal battery 210 prevents scenarios in which the internal battery 210 is being charged and the device 100 is not being charged. If a user connects the charging case 200 to an external power source 206 in order to charge its internal battery 210 and then subsequently connects the device 100 to the charging case 200 to charge the battery 106 of the device 100, the MCU 224 detects that the device 100 is now connected and that its battery 106 requires charging. In response to this, as described above, the MCU 224 configures the first switch 220 and the second switch 222 in an ON state and the charging IC 226 prevents power being provided to the internal battery 210. In this way, power is directed from the external power source 206 to the battery 106 of the device 100 rather than to the internal battery 210 of the charging case 200.

In another example, the MCU 224 determines that the device 100 and the internal battery 210 are under charged and that the power available from the external power source 106 is sufficient to meet the charging requirements of the battery 106 of the device 100 and the internal battery 210 at the same time. For example, the external power source 206 may supply 20V whereas the battery of the device 100 only requires a supply voltage of 5V for charging. In this scenario, the MCU 224 again configures the first switch 220 and second switch 222 to both be in an ON state via the switch control lines 274 and 276 respectively but the charging IC 226, under the control of the MCU 224, also enables power to be provided from the power source 206 to the internal battery 210. Accordingly, the battery 106 of the device 100 and the internal battery 210 are charged by the external power source 206 simultaneously. The MCU 224 (and Charging IC 226 monitor the voltage of the internal battery 210 via monitoring line 290 to prevent overload but at the same time maintain the internal battery 210 charging current as high as possible to minimize the charging time.

FIG. 6 is a schematic diagram illustrating the internal components of a charging case 300 according to a second example. For brevity, components that are the same as or equivalent to components of the charging case 200 described above with reference to FIG. 5 have the same reference numerals as used in FIG. 5 but increased by 100.

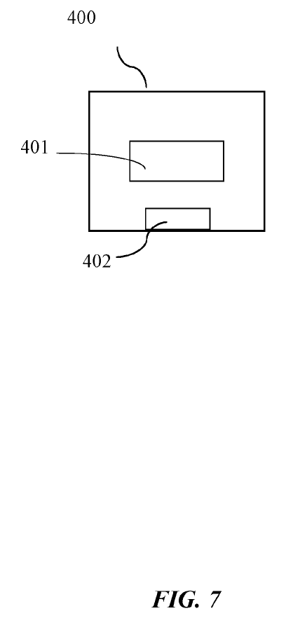

In this example, the charging case 300 comprises a device detection unit 392 which is arranged to detect when a device, such as the device 100, is connected to the first connection port 302. An example of the device detection unit 392 is described below in more detail in relation to FIG. 7.

The MCU 324 is connected to the second connection port 304 via a monitoring line 383 and uses the monitoring line 383 to detect that a device or external power source is connected to the second connection port 304.

The MCU 324 is connected to the first connection port 302 via a data line 385 and uses the data line 385 to receive data from or transmit data to the device 100 when the device 100 is connected to the first connection port 302.

The charging case 300 comprises an input protection unit 399 for protecting the Charging IC 326.

The charging case 300 also comprises a fuel gauge 394 that is in series with an electrical connection 396 between the internal battery 310 and the charging IC 326. The fuel gauge 394 measures the charge status of the internal battery 310.

In this example, the control circuitry 308 comprises a first switch 320, a second switch 322, and a third switch 398 which are controlled by the MCU 324 via a switch control lines 374a (there is control line for each switch although for simplicity only a single line is shown in FIG. 6).

In a first example, the device 100 is connected to the first connection port 302 of the charging case 300, the battery 106 of the device 100 is under charged and the second connection port 304 is not in use (i.e. not active). In this scenario, the MCU 324 detects via the device detection unit 392 that the device 100 is connected to the charging case 300 and determines via the monitoring line 383 and/or the monitoring line 372 that the second connection port 304 is not in use. The MCU 324 configures the first switch 320 and the second switch 332 to both be in an OFF state and the third switch 398 to be in an ON state. With the switches in this configuration, electrical power stored in the internal battery 310 is provided vis the charging IC 326 and the first connection port 302 to charge the battery 106 of the device 100. No electrical power can flow to the second connection port 304.

In a second example, an external power source 206 is connected to the charging case 300 via the second connection port 304 and the internal battery 310 is under charged and the first connection port 302 is not in use. In this scenario, the MCU 324 detects via the monitoring line 383 and/or monitoring line 372 that the external power source 206 is connected to the second connection port 304 and detects via the device detection unit 392 that the device 100 is not connected to the charging case 300. The MCU 324 configures the first switch 320 to be in an ON state and the second switch 322 and the third switch 398 to both be in an OFF state. With the switches in this configuration, electrical power is provided from the external power source 206 via the charging IC 326 to charge the internal battery 310.

In a third example, a non-power source device 400, an example of which is schematically illustrated in FIG. 7, is connected to the charging case 300 via the second connection port 304. The non-power source device 400 comprises its own internal battery 401 and a connection port 402, similar to the connection ports described above, for making the connection to the second connection port 304.

The non-power source devices may, for example, be a camera, mobile telephones, a GPS devices or the like.

In this example, the first connection port 302 is not in use. In this scenario, the MCU 324 detects via the monitoring line 383 and/or monitoring line 372 that a non – power source device 400 is connected to the second connection port 304 and detects via the device detection unit 392 that the device 100 is not connected to the charging case 300. The MCU 324 configures the first switch 320 to be in an ON state and the second switch 322 and the third switch 398 to both be in an OFF state. With the switches in this configuration, electrical power from the internal battery 310 is provided via the charging IC 326 to charge the internal battery 401 of the non – power source device 400.

In a fourth example, the device 100 and the non-power source device 400 are both connected to the charging case 300 via the first connection port 302 and the second connection port 304 respectively. The MCU 324 detects that the device 100 is connected to the first connection port 302 via the device detection unit 392 and that the non-power source device 400 is connected to the second connection port 304 via the monitoring line 383 and/or monitoring line 372.

The MCU 324 prioritises charging the battery 106 of the device 100 over charging the battery 401 of the non – power source device 400.

In this example, the MCU 324 configures the first switch 320 and the second switch 322 to be in OFF state and the third switch 398 to be in an ON state. Accordingly, electrical power is provided from the internal battery 310 via a path including the charging IC 326, the third switch 322 and first connection port 302 to charge the battery 106 of the device 100.

The MCU 324 monitors the charge status of the battery 106 of the device 100 to determine when the battery 106 of the device 100 reaches a predetermined charge level, for example fully charged, and no longer requires electrical power to be supplied to it. In response to this determination being made, the MCU 324 configures the first switch 320 into an ON state, the third switch 398 into an OFF state and maintains the second switch 322 in an OFF state. With the switches in this configuration, power is provided from the internal battery 310 through a path including the charging IC 326, the first switch 320 and the second connection port 302 to charge the battery 401 of the non-power source device 400.

In some examples, simultaneous charging of both the battery 401 of the non power source 400 device and the battery 106 of the device 100 will occur if there is sufficient electrical power available from the internal battery 310. That is to say, the battery 106 of the device 100 is being charged at full capacity and the internal battery 310 is able to provide additional power to charge the battery 401 of the device 400.

In a fifth example, the device 100 and the external power source 106 are both connected to the charging case 300 via the first connection port 302 and the second connection port 304 respectively. The MCU 324 detects that the device 100 is connected to the first connection port 202 via the device detection unit 392 and that the external power source 106 is connected to the second connection port 304 via the monitoring line 383 and/or monitoring line 370.

The MCU 324 prioritises charging the battery 106 of the device 100 over charging the internal battery 310.

In one scenario, the MCU 324 determines that the battery 106 of the device 100 is under charged and that the internal battery 310 is under charged but that the power available from the power source 106 is sufficient only to meet the charging requirements of the battery 106 of the device 100. For example, the battery 106 of the device 100 may require a certain minimum supply voltage, e.g. 5V for charging, and the power source 106 can only supply 5V. In this scenario, the MCU 324 configures the first switch 320 and the third switch 398 to be in OFF state and the second switch 322 to be in an ON state. Accordingly, in this scenario, electrical power is provided from the external power source 106 through a path including by the second connection port 304, the second switch 322 and first connection port 302 to charge the battery 106 of the device 100.

The MCU 324 monitors the charge status of the battery 106 of the device 100 to determine when the battery 106 of the device 100 reaches a predetermined charge level, for example fully charged, and no longer requires electrical power to be supplied to it. In response to this determination being made, the MCU 324 configures the first switch 320 into an ON state and the second switch 322 into an OFF state while maintaining the third switch 398 in an OFF state. With the switches in this configuration, power is provided from the power source 106 to charge the internal battery 310 and no power is provided to the device 100.

In an alternative scenario, the MCU 324 determines that the battery of the device 100 and the internal battery 310 are under charged and that the power available from the external power source 206 is sufficient to meet the charging requirements of both simultaneously. In this scenario, the MCU 324 configures the first switch 320 and second switch 322 to both be in an ON state and the third switch 398 to be in an OFF state. With the switches in this configuration, power is provided from the power source 106 to charge the internal battery 210 and the battery 106 of the device 100 simultaneously.

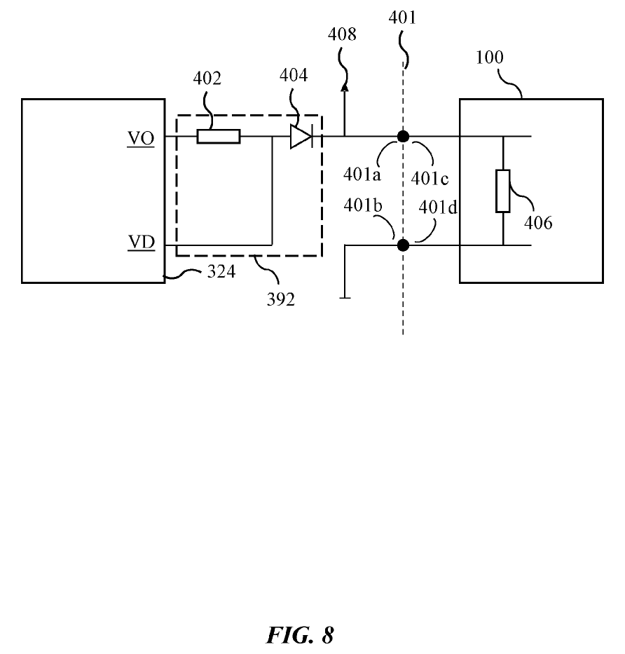

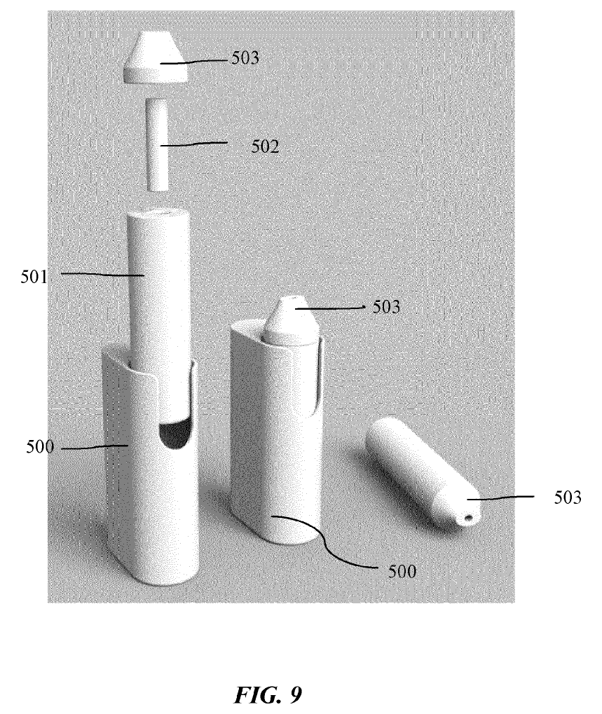

FIG. 8 is a schematic illustration of the MCU 324 and the device detection unit 392 (represented by the dashed box) of a charging case 300 as described above and the device 100. The dashed line 401 represents an interface between the charging case 300 and the device 100 when the device 100 is connected to the charging case 300.

The MCU 34 comprises a voltage output pin VO and a voltage detection pin VD. The device detection unit 392 comprises a resistor 402, a diode 404 and first 401a and second 402b contacts. A first end of the resistor 402 is connected to the Voltage output pin VO and a second end of the resistor 402 is connected to the voltage detection pin VD and an anode of the diode 404. A cathode of the diode 404 is connected to the first contact 401a. The second contact 401b is connected to ground.

The device 100 comprises third 401c and fourth 401d electrical contacts and a resistor 406 connected across the third 401c and the fourth 401d electrical contacts.

When the device 100 is connected to the charging case 300, the first electrical contact 401a contacts the third electrical contact 401c and the second electrical contact 401b contacts the fourth electrical contact 401d.

In use, the Voltage output pin VO of the MCU 324 outputs a small fixed voltage and the MCU 324 monitors for a detection voltage level at the detection pin VD.

When the device 100 is connected to the charging case 300, the resistor 402 and the resistor 406 form a potential divider and so the voltage level at the detection pin VD drops to a predetermined detection voltage which is detected by the MCU 324

The reduction in voltage that the MCU 324 detects when the device 100 is connected to the charging case will be determined by the two resistances of the resistors 402 and 406. Accordingly, knowing the two resistances will allow the MCU to identify if the device 100 is connected or a different, un-compatible device. Therefore, it can be envisaged that if an un-compatible device having a different internal resistance/resistor is connected, the MCU 324 will be able to identify this and prevent the +5V supply 408.

The charging case 300 may comprises alternative arrangements to detect when the device 100 is connected, for example, a Hall or a mechanical switch.

In the illustrated examples above, the first electrical connection ports 202 and 302 are bespoke two pin connection ports. Alternatively, the first electrical connection port 202, 302 may be a standard pin connection port, for example, USB type C, or micro-USB or the like. Although in the above examples the first connection ports 202, 302 and second connection ports 204, 304 are described as being pin connectors, it will be appreciated that alternate connection ports may be used to transfer power and/or data into and out of the device. For example, wireless connection ports, wireless charging systems and the like.

FIG. 9 shows a charging case or carry case 500 and the non-combustible aerosol provision device 501 according to an embodiment of the present invention. According to an embodiment a carry case 500 is provided which comprises a battery charging pack. The battery charging pack has an aperture or slot for receiving and charging a non-combustible aerosol provision device 501. According to an embodiment the non-combustible aerosol provision device 501 may comprise an aerosol-generating material heating device, also known as a heat-not-burn device, tobacco heating device, etc., as described above. In such examples, the aerosol generating material may not be in liquid form.

In some examples, the non-combustible aerosol provision device 501 is a hybrid device to generate aerosol using a combination of aerosol-generating materials 502. In some such examples, one or a plurality of the aerosol-generating materials 502 may be heated. Each of the aerosol-generating materials 502 may be, for example, in the form of a solid, liquid, wax or gel and may or may not contain nicotine. In some examples, the hybrid system comprises a liquid or gel aerosol-generating material and a solid aerosol-generating material. The solid aerosol-generating material 502 may comprise, for example, tobacco or a non-tobacco product.

The aerosol provision device 501 is configured to receive a replaceable article 502 (or consumable) comprising aerosol generating material, and to generate an aerosol or inhalable medium from the material to be inhaled by the device user.

The device 501 further comprises a mouthpiece 503 which engages with the housing of a body of the device 501 at a first end thereof. The mouthpiece 503 comprises a first, or distal, end, which forms a substantially flat surface which abuts the first end of the body. The mouthpiece 503 extends from the first end to a second, or proximal, end configured for the user to draw on and inhale aerosol from.

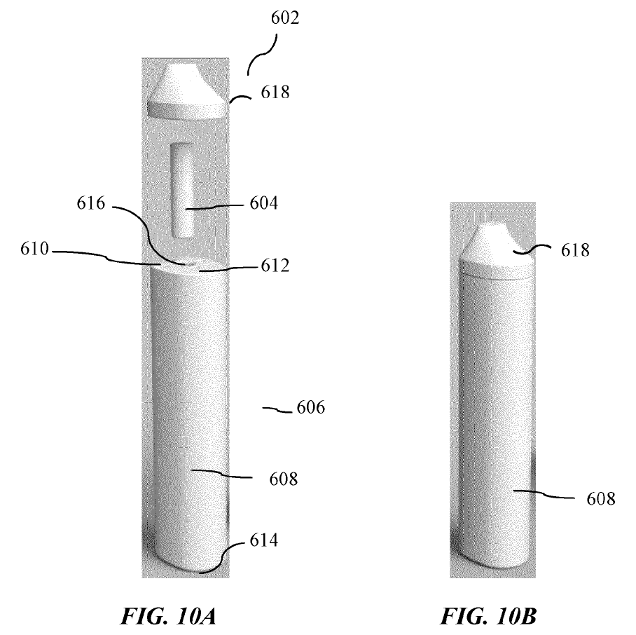

FIG. 10A shows a perspective exploded view of an aerosol provision device 602 for generating aerosol from an aerosol generating material 604. The aerosol provision device 602 is configured to receive a replaceable article 604 (or consumable) comprising the aerosol generating material, and to generate an aerosol or inhalable medium from the material to be inhaled by the device user.

The aerosol provision device 602 comprises a body 606 having a housing 608 (or outer cover) which surrounds and houses various components of the device 602 within the body 606. The device 602 comprises a chamber 610 within the housing 608 for receiving the article 604 into the device 602. The body 606 has a first end 612, which may comprise a substantially flat or planar surface as illustrated. The first end 612 may also be referred to as the proximal end, as the end is closest to the user during use of the device. The body 606 further comprises a second, or distal, end 614.

An opening 616 is formed through the housing 608 at the first end 612 of the body 606, the opening 616 connecting the chamber 610 to an exterior of the housing 608. The article 604 may be inserted into the chamber 610 through this opening 616 in the first end 612. The chamber 610 is sized and shaped to receive the article 604 in a sliding fit. The chamber 610 may have a corresponding shape to that of the intended article 604, for example a cylindrical shape, and may be sized to have a cross-sectional area slightly larger than that of the article 604 in order to receive and hold the article 604 in a sliding fit.

In the inserted state, the article 604 is only partially received by the chamber 610; that is, a portion of the article 604 protrudes out of the chamber 610 through the opening 616 to extend outwardly of the housing 608 away from the first end 612 of the body 606.

The device 602 further comprises a heating system (not shown) within the housing 608 of the body 606, the heating system in heat communication with the chamber 610, so as to heat the article 604 and generate the inhalable medium. The heating system may comprise a coil inductor which surrounds a ferrous material in the chamber 610, the coil inductor powered by a battery disposed within the housing 608.

The device 602 further comprises a mouthpiece 618 which engages with the housing 608 of the body 606 at the first end 612 thereof. The mouthpiece 618 comprises a first, or distal, end, which forms a substantially flat surface which abuts the first end 612 of the body 606. The mouthpiece 618 extends from the first end to a second, or proximal, end configured for the user to draw on and inhale aerosol from.

The mouthpiece 618 of the pictured embodiment is completely removable from, and replaceable to, the housing 608 by the user. When the mouthpiece 618 of the device 602 is removed from the first end 612 of the body 606 it is unattached to any portion of the body 606 or housing 608 thereof. When the mouthpiece 618 is replaced onto the body 606, it can be re-engaged with the housing 608 at the first end 612 of the body 606.

In other embodiments, the mouthpiece 618 may be partially removable from the body 606 by the user. When the mouthpiece 618 of the device 602 is partially removed from the first end 612 of the body 606, it remains partially attached to the body 606, for example by a hinge which is attached to the housing 608 and to the mouthpiece 618. The mouthpiece 618 may then be fully re-engaged with the first end 612 of the body 606 by the user.

The mouthpiece 618 comprises a passage which extends from a first opening in the first, distal end to a second opening in the second, proximal end. When the mouthpiece 618 is engaged to the first end 612 of the body 606 and an article 604 is partially received by the chamber 610 in the housing 608, the remaining or protruding portion of the article 604 is received by the mouthpiece 618 through the first opening in the first, distal end, and into the passage.

The passage defines an interior wall which circumscribes the passage. When the mouthpiece 618 is engaged to the first end 612 of the body 606, the article 604 contacts the interior wall of the passage so as to form a seal with the interior wall. The article 604 may contact the interior wall around substantially the full circumference of the interior wall, so as to form a sealing contact which fully circumscribes the passage. The engagement between the article 604 and the interior wall may be so as to partially or fully seal the passage to limit or prevent the free passage of aerosol or air through the passage past the sealing contact.

The sealing contact may be formed due to the shape and size of the passage relative to the article 604. The passage may have a cross-sectional shape which corresponds to a cross-sectional shape of the article 604, so as to receive the article 604 therein. For example, both the passage and article 604 may comprise a circular cross-section, forming cylindrical shapes. The passage cross-sectional size may be slightly smaller than the cross-sectional size of the article 604, so that the article 604 forms a press-fit with the interior wall of the passage and a sealing contact as described above.

The passage may comprise a changing cross-section along the length between the distal end opening and the proximal end opening. The passage may comprise a first, or distal portion with a first cross-section and a second, or proximal portion with a second cross-section, where the area of the first cross-section is larger than the area of the second cross-section. The first portion of the passage extends from the distal end opening to partway along the full length of the passage up to a transition point. The second portion extends from the transition point to the proximal end opening.

The first portion of the passage is configured to receive the article 604 so that the interior wall in the first portion contacts the article 604 in the manner described above. As such, the first portion of the passage may be sized to have a cross-sectional size slightly smaller than the cross-sectional size of the article 604 so as to form the sealing contact. The second portion is sized to be smaller than the first portion so that the article 604 is prevented from extending fully through the passage to the second, proximal end of the mouthpiece 618.

The device 602 comprises an attachment means which removably attaches the mouthpiece 618 to the housing 608. The attachment means generates a force which brings the mouthpiece 618 into bearing with the housing 608 at the first end 612 of the body 606 and the first, distal end of the mouthpiece 618. By bringing the mouthpiece 618 into bearing with the housing 608 of the device body 606, the attachment means helps to form the contact between the interior wall of the mouthpiece passage and the article 604, which in turn forms the sealing contact.

In embodiments, the attachment means may comprise a magnet. In the embodiment shown, the attachment means comprises a plurality of magnets. The illustrated plurality of magnets includes a plurality of magnets which are disposed in or on the housing 608 at the first end 612 of the body 606 and a plurality of magnets which are disposed in the first, distal end of the mouthpiece 618. The two pluralities of magnets are arranged to attract one another, i.e. by having opposed polarities, and so bring the first, distal end of the mouthpiece 618 into bearing with the housing 608 at the first end 612 of the body 606.

The magnets are recessed into the respective first end 612 of the body 606 and distal end of the mouthpiece 618 so that the housing 608 of the body 606 and the mouthpiece 618 may form a flush contact along their respective surfaces. In other embodiments, the magnet, magnets or ferrous material may be disposed under a surface of the housing 608 at the first end 612 of the body 606 and under a surface of the first, distal end of the mouthpiece 618 so as to be covered by the surfaces and obscured from visibility. The magnets will still attract and being the mouthpiece 618 and housing 608 together.

The plurality of magnets in the mouthpiece first, distal end are arranged in a ring shape around the first opening which is formed therein, and the plurality of magnets in the housing 608 at the first end 612 of the device body 606 are similarly arranged in a ring shape around the opening to the chamber 610. The pluralities of magnets in the housing 608 and the mouthpiece 618 are arranged in a corresponding manner to one another so that each magnet in the housing 608 aligns with one magnet of the mouthpiece 618 when the mouthpiece 618 is in engagement with the housing 608. In the embodiment shown, there are four magnets disposed in each of the first end 612 of the device body 606 and the first, distal end of the mouthpiece 618.

In other embodiments, only one of the mouthpiece 618 or the housing 608 of the body 606 may comprise a magnet or a plurality of magnets. In such an embodiment, the respective other of the housing 608 or the mouthpiece 618 comprises a region of ferrous material in the first end 612 of the body 606 or the first, distal end of the mouthpiece 618, so as to engage with the magnets of the other. The region of ferrous material may comprise a strip of ferrous material recessed into the first end 612 of the body 606 or the first, distal end of the mouthpiece 618. Alternatively, substantially a whole surface of the first end 612 of the body 606 or the first, distal end of the mouthpiece 618 could comprise a ferrous material.

Other attachment means are envisaged as within the scope of the disclosure. For example, the housing 608 and mouthpiece 618 may comprise respective screw and thread connections, so that the mouthpiece 618 and the housing 608 could be brought into bearing by a threaded connection.

In use, the user removes the mouthpiece 618 from the housing 608 of the device 602 so as to expose the opening in the first end 612 and the chamber 610. The user inserts the article 604 into the chamber 610 through the opening. The user then replaces the mouthpiece 618 onto the housing 608 at the first end 612 of the body 606; the protruding portion of the article 604 is received within the passage of the mouthpiece 618 through the first opening formed in the first, distal end of the mouthpiece 618, and the first, distal end of the mouthpiece 618 is brought into bearing with the housing 608 at the first end 612 of the body 606 by the attachment means. The article 604 forms a sealing contact with the interior surface of the passage of the mouthpiece 618 in the manner described above.

The user may then turn the device 602 ON, or otherwise cause the device 602 to activate the heating system. The heating system, in heating communication with the chamber 610, heats the portion of the article 604 which is disposed within the chamber 610. The heating of the article 604 causes generation of an aerosol as described above. The aerosol passes up through the article 604 and into the passage of the mouthpiece 618, past the sealing contact in the proximal direction. The sealing contact ensures that the aerosol does not travel backwards down the mouthpiece passage towards the first, distal end, but instead is directed towards the second, proximal end of the mouthpiece 618 and the second opening, where the user may inhale the aerosol.

Once the user has finished a use or session with the device 602, the mouthpiece 618 may be removed from the housing 608 again, and the article 604 may be removed from the chamber 610 and disposed of. The device 602 is then ready to receive another article 604 for a subsequent use.

It should be understood that, in embodiments where the mouthpiece 618 is only partially removable from the housing 608, the step of removing the mouthpiece 618 described above may comprise partially removing the mouthpiece 618 to expose the chamber 610.

By receiving the consumable article 604 directly into the mouthpiece 618, the device 602 may provide a compact aerosol-generation solution. The contact between the article 604 and mouthpiece 618 provides direction of generated aerosol towards the user, to improve user experience. The use of a mouthpiece 618 may further improve user experience by providing a separation between the consumable and the user, reducing undesirable phenomena such as ‘hot puff’.

In an embodiment, the device 602 may comprise a secondary attachment means for attaching the mouthpiece 618 to the housing 608 at a location on the body 606 other than the first end 612 of the body 606. For example, the secondary attachment means may be arranged in or on the housing 608 at one lateral side of the body 606.

In embodiments where the attachment means comprises a magnet or magnets, the secondary attachment means may also comprise a magnet or magnets or a region of ferrous material which is disposed on or in the housing 608. The magnet, magnets or ferrous material which is disposed in the mouthpiece 618 to form part of the attachment means can therefore attach the mouthpiece 618 to the housing 608 away from the first end 612 of the body 606.

In use, the user may use the secondary attachment means to hold the mouthpiece 618 to the housing 608 subsequent to removing the mouthpiece 618 from the housing 608 at the first end 612 of the body 606, and prior to inserting the article 604 into the chamber 610. The secondary attachment means thereby provides a convenient facility for holding the mouthpiece 618 while the user is preparing the device 602 for use.

The device 602 may also include an input interface, which may comprise a button or switch, which operates the device 602 when pressed. For example, a user may turn on the device 602 by operating the input interface. The input interface may be formed as part of the housing 608. The input interface allows the user to activate the heating system as described above.

The device 602 may also comprise an electrical connector/component, such as a socket/port, which can receive a cable to charge the battery of the device 602 which is disposed in the body 606. For example, the socket may be a charging port, such as a USB charging port. In some examples the socket may be used additionally or alternatively to transfer data between the device 602 and another device, such as a computing device. The socket may be arranged in the housing 608.

With reference back to FIG. 9, according to a preferred embodiment a charging apparatus 500 is preferably provided having a first power source (not shown). The first power source may, for example, comprise a rechargeable battery which is provided within the body of the charging apparatus 500.

The charging apparatus 500 preferably comprises a first device (e.g. electrical port) for supplying electrical power to a non-combustible aerosol provision device 501. According to a preferred embodiment the non-combustible aerosol provision device 501 comprises a tobacco heating product device.

The charging apparatus 500 preferably comprises a second device (e.g. electrical port) for receiving electrical power from an external power source e.g. mains.

In a first mode of operation the charging apparatus 500 is preferably arranged to supply electrical power to one or more aerosol generators of the non-combustible aerosol provision device 501. As discussed above, the one or more aerosol generators of the non-combustible aerosol provision device 501 may comprise one or more inductive or resistive heaters.

The charging apparatus 500 is preferably portable. According to an embodiment the charging apparatus 500 comprises a portable handheld charging apparatus.

According to an embodiment in the first mode of operation the first power source (e.g. rechargeable battery housed within the charging apparatus 500) is preferably arranged to supply electrical power to the one or more aerosol generators of the non-combustible aerosol provision device 501. It is contemplated that according to various embodiments in the first mode of operation the non-combustible aerosol provision device 501 receives power from the battery of a portable charging case 500 rather than from an external power source during use.

In the first mode of operation, the charging device may be arranged to simultaneously supply electrical power to the one or more aerosol generators of the non-combustible aerosol provision device, while also supplying electrical power to the first power source (e.g. rechargeable battery housed within the charging apparatus 500) and/or to a second power source housed within the non-combustible aerosol provision device (e.g. rechargeable battery housed within the non-combustible aerosol provision device). In some examples, simultaneous charging of one or both the battery of the portable charging case 500 and the battery of the non-combustible aerosol provision device will occur alongside supply electrical power to the one or more aerosol generators of the non-combustible aerosol provision device if there is sufficient electrical power available from the external power source.

In particular, it is contemplated that the non-combustible aerosol provision device 501 (e.g. tobacco heating product device) may be operated whilst housed in the charging case 500. It is contemplated that the non-combustible aerosol provision device 501 may be operated whilst housed in the charging case 500 and whilst the second power source (e.g. rechargeable battery of the non-combustible aerosol provision device) is being charged by the charging case 500. The non-combustible aerosol provision device 501 may be operated whilst housed in the charging case 500 and whilst the first power source (e.g. rechargeable battery of the charging case 500) is being charged from an external power source. The non-combustible aerosol provision device 501 may be operated whilst housed in the charging case 500 and whilst both the first and second power sources are being charged. In this case, the second power source may receive electrical power from the first power source and the first power source may receive power from the external power source, or, alternatively, both the first power source and the second power source may receive power from the external power source.

The non-combustible aerosol provision device 501 may be considered to comprise a pen like device and may comprise a relative small rechargeable battery or other power source.

According to an embodiment the non-combustible aerosol provision device 501 may have a battery which enables the non-combustible aerosol provision device 501 to be used 2 times. In addition, the carry case 500 may also enable the non-combustible aerosol provision device 501 to be used 20 times, so that the non-combustible aerosol provision device 501 and the carry case 500 enable the device to be used 22 times in total between charges.

According to an embodiment the non-combustible aerosol provision device 501 may have a battery which enables the non-combustible aerosol provision device 501 to be used 6 times. In addition, the carry case 500 may also enable the non-combustible aerosol provision device 501 to be used 15 times, so that the non-combustible aerosol provision device 501 and the carry case 500 enable the device to be used 21 times in total between charges.

According to an embodiment the non-combustible aerosol provision device 501 may have a battery which enables the non-combustible aerosol provision device 501 to be used approx. 30 times.

Aerosol-generating articles for aerosol-generating devices (such as tobacco heating products) usually contain more water and/or aerosol-generating agent than combustible smoking articles to facilitate formation of an aerosol in use. This higher water and/or aerosol-generating agent content can increase the risk of condensate collecting within the aerosol-generating device during use, particularly in locations away from the heating unit(s). This problem may be greater in devices with enclosed heating chambers, and particularly those with external heaters, than those provided with internal heaters (such as “blade” heaters). Without wishing to be bound by theory, it is believed that since a greater proportion/surface area of the aerosol-generating material is heated by external-heating heating assemblies, more aerosol is released than a device which heats the aerosol-generating material internally, leading to more condensation of the aerosol within the device 501. It has been found that programmed heating profiles may advantageously be employed in a device 501 configured to externally heat aerosol-generating material to provide a desirable amount of aerosol to the user whilst keeping the amount of aerosol which condenses inside the device low. For example, the maximum operating temperature of a heating unit may affect the amount of condensate formed. It may be that lower maximum operating temperatures provide less undesirable condensate. The difference between maximum operating temperatures of heating units in a heating assembly may also affect the amount of condensate formed. Further, the point in a session of use at which each heating unit reaches its maximum operating temperature may affect the amount of condensate formed.

In some embodiments, the device 501 is operable in at least a first (e.g. base) mode and a second (e.g. boost) mode.

The heating assembly may be operable in a maximum of two modes, or may be operable in more than two modes, such as three modes, four modes, or five modes.

Each mode may be associated with a predetermined heating profile for each heating unit in the heating assembly, such as a programmed heating profile. One or more of the programmed heating profiles may be programmed by a user. Additionally, or alternatively, one or more of the programmed heating profiles may be programmed by the manufacturer. In these examples, the one or more programmed heating profiles may be fixed such that an end user cannot alter the one or more programmed heating profiles.

The modes of operation may be selectable by a user. For example, the user may select a desired mode of operation by interacting with a user interface. Preferably, power begins to be supplied to the first heating unit at substantially the same time as the desired mode of operation is selected.

Each mode may be associated with a temperature profile which differs from the temperature profiles of the other modes. Further, one or more modes may be associated with a different point at which the device is ready for use. For example, the heating assembly may configured such that, in the first mode, the device 501 is ready for use a first period of time after the start of a session of use, and in the second mode, the device 501 is ready for use a second period of time after the start of the session. The first period of time may be different from the second period of time. Preferably, the second period of time associated with the second mode is shorter than the first period of time associated with the second mode.

In some examples, the heating assembly is configured such that the device is ready for use within 30, 25 seconds, 20 seconds or 15 seconds of supplying power to the first heating unit when operated in the first mode. The heating assembly may also be configured such that the device is ready for use in a shorter period of time when operating in the second mode - within 25 seconds, 20 seconds, 15 seconds, or 10 seconds of supplying power to the first heating unit when operating in the second mode. Preferably, the heating assembly is configured such that the device is ready for use within 20 seconds of supplying power to the first heating unit when operated in the first mode, and within 10 seconds of supplying power to the second heating unit when operated in the second mode. Advantageously, the second mode of this embodiment may also be associated with the first and/or second heating unit having a higher maximum operating temperature in use.

In a particularly preferred embodiment, the device 501 is configured such that the indicator indicates that the device is ready for use within 20 seconds of selection of the first (e.g. base) mode, and within 10 seconds of selection of the second (e.g. boost) mode.

Providing an aerosol-generating device 501 such as a tobacco heating product with a heating assembly that is operable in a plurality of modes (e.g. base mode and boost mode) advantageously gives more choice to the consumer, particularly where each mode is associated with a different maximum heater temperature. Moreover, such a device 501 is capable of providing different aerosols having differing characteristics, because volatile components in the aerosol-generating material will be volatilised at different rates and concentrations at different heater temperatures. This allows a user to select a particular mode based on a desired characteristic of the inhalable aerosol, such as degree of tobacco flavour, nicotine concentration, and aerosol temperature. For example, modes in which the device is ready for use more quickly (e.g. a second or “boost” mode) may provide a quicker first puff, or a greater nicotine content per puff, or a more concentrated flavour per puff. Conversely, modes in which the device is ready for use at a later point in the session (e.g. a first or base mode) of use may provide a longer overall session of use, lower nicotine content per puff, and more sustained delivery of flavour.

In embodiments wherein the device 501 is ready for use more quickly in a second (e.g. boost) mode, and/or the first and/or second heating unit has a higher maximum operating temperature in the second mode, the second mode may be referred to as a “boost” mode. An aerosol-generating device 501 is preferably provided which is operable in a first “normal” mode, and a second “boost” mode. The “boost” mode may advantageously provide a quicker first puff, or a greater nicotine content per puff, or a more concentrated flavour per puff.

The device 501 may comprise a maximum of two heating units. In other examples, the device 501 may comprise more than two independently controllable heating units, such as three, four or five independently controllable heating units.

Embodiments are contemplated wherein the non-combustible aerosol provision device 501 receives power from the battery of a charging case 500 (or another portable electronic device such as a mobile phone or smartphone) via a wired or wireless connection. Less preferred embodiments are contemplated wherein the non-combustible aerosol provision device 501 receives power from an external power source e.g. mains via a wireless connection.

In the first mode of operation the charging apparatus may be arranged to supply electrical power to one or more aerosol generators of a non-combustible aerosol provision device 501 so that the one or more aerosol generators generate aerosol from one or more aerosol-former materials.

The first device may be arranged to supply electrical power to the non-combustible aerosol provision device 501 via either: (i) a wired connection; and/or (ii) a wireless connection.

The second device may be arranged to receive electrical power from an external power source via either: (i) a wired connection; and/or (ii) a wireless connection.

The charging apparatus and/or a non-combustible aerosol provision device 501 may be arranged to detect that the non-combustible aerosol provision device 501 may be mechanically coupled to, held within or may be otherwise inserted into or within the charging apparatus 500.

The charging apparatus 500 and/or the non-combustible aerosol provision device 501 may be arranged to detect that a non-combustible aerosol provision device 501 may be electrically coupled to the charging apparatus 500.

The charging apparatus 500 may further comprise a third device for receiving a signal from the non-combustible aerosol provision device 501 that the non-combustible aerosol provision device may be either: (i) mechanically coupled to, held within or may be otherwise inserted into or within the charging apparatus 500; and/or (ii) may be electrically coupled to the charging apparatus 500.

In a second mode of operation the charging device 500 may be arranged to supply electrical power to a second power source housed within a non-combustible aerosol provision device 501.

In the first mode of operation the charging device 500 may be further arranged to supply electrical power to the first power source and/or to a second power source housed within a non-combustible aerosol provision device 501.

In a mode of operation electrical power may be diverted from supplying electrical power to the one or more aerosol generators in order to supply electrical power to either recharge the first power source and/or to recharge a second power source housed within a non-combustible aerosol provision device 501.

One or more indicators (not shown) may be arranged to indicate the charge status of the first power source (e.g. rechargeable battery within the carry case 500) and/or a second power source (e.g. rechargeable battery) housed within a non-combustible aerosol provision device 501.

The one or more indicators preferably comprise one or more light emitting diodes.

The charging apparatus preferably comprises a portable carry case for storing the non-combustible aerosol provision device 501.

According to the preferred embodiment a charging apparatus 500 as described above in combination with a non-combustible aerosol provision device 501 is provided.

The non-combustible aerosol provision device 501 may be mechanically coupled and/or electrically coupled to the charging apparatus 500 in use.

One or more aerosol-former materials (e.g. tobacco rod consumables) 502 may be provided, wherein optionally the one or more aerosol-former materials 502 are inserted or otherwise retained, in use, within the non-combustible aerosol provision device 501.

Various embodiments also relate to a method which involves providing a charging apparatus coupled to a non-combustible aerosol provision device comprising one or more aerosol generators. The method further comprises supplying electrical power from the charging apparatus to the one or more aerosol generators.

Apparatus comprising a charging apparatus 500 and/or a non-combustible aerosol provision device 501 is also disclosed. Either the charging apparatus 500 and/or the non-combustible aerosol provision device 501 may further comprise a securing or retaining feature which secures or retains the non-combustible aerosol provision device 501 to the charging apparatus 500.

According to an embodiment the securing or retaining feature which secures or retains the non-combustible aerosol provision device 501 to the charging apparatus 500 may enable the non-combustible aerosol provision device 501 to be retained within the charging apparatus 500 such that the aerosol provision device 501 and the charging apparatus 500 may be inverted or turned upside down.

The securing or retaining feature may comprise one or more magnets, magnetic or ferrous materials.

The charging apparatus may comprise one or more magnets, magnetic or ferrous materials.

The non-combustible aerosol provision device may comprise one or more magnets, magnetic or ferrous materials.

According to an embodiment the magnet strength is preferably greater than the device weight. According to an embodiment the combined magnet strength on the mouthpieces is preferably greater than the device weight in combination with the charger magnetic force. This enables the device to not fall out of the charger if turned upside down. It also means the consumer can remove the holder from the case by pulling on the mouthpiece.

Alternatively, the mouthpiece 503 magnet strength may be less than the device weight in combination with the charger magnet. The enables the mouthpiece 503 to be removed without accidently moving the holder from the charger.

The charging apparatus may comprise a portable carry case 500 for storing the non-combustible aerosol provision device 501.

The apparatus may further comprise one or more aerosol-former materials 502, wherein optionally the one or more aerosol-former materials 502 are inserted or otherwise retained, in use, within the non-combustible aerosol provision device 501.

A system is disclosed comprising a charging apparatus 500 and a non-combustible aerosol provision device 501. Either the charging apparatus 500 and/or the non-combustible aerosol provision device 501 further comprise a securing or retaining feature which secures or retains the non-combustible aerosol provision device 501 to the charging apparatus 500.

The securing or retaining feature may comprise one or more magnets, magnetic or ferrous materials.

A method is disclosed comprising providing a charging apparatus 500 and a non-combustible aerosol provision device 501 and securing or retaining the non-combustible aerosol provision device 501 to the charging apparatus 500.

The step of securing or retaining the non-combustible aerosol provision device 501 to the charging apparatus 500 may further comprise securing or retaining the non-combustible aerosol provision device 501 to the charging apparatus 500 using one or more magnets. However, the use of magnets is not essential and other embodiments are contemplated wherein a mechanical latching mechanism is used.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A non-combustible aerosol provision system comprising a non-combustible aerosol provision device and a charging apparatus for use with the non-combustible aerosol provision device,
the non-combustible aerosol provision device comprising:
a first rechargeable battery, and
a plurality of independently controllable aerosol generators,
the charging apparatus comprising:
a housing,
a second rechargeable battery disposed within the housing;
a first electrical connection port for connecting to the non-combustible aerosol provision device;
a second electrical connection port for connecting to an external power source; and
control circuitry, wherein, in use, when the external power source is connected to the second electrical connection port and the non-combustible aerosol provision device is connected to the first electrical connection port, the control circuitry prioritises directing electrical power from the external power source to the non-combustible aerosol provision device to charge the first rechargeable battery over directing electrical power from the external power source to charge the second rechargeable battery,
wherein when the external power source is connected to the second electrical connection port and the non-combustible aerosol provision device is connected to the first electrical connection port, the control circuitry determines whether the external power source has sufficient power to charge the second rechargeable battery and the first rechargeable battery simultaneously and if the control circuitry determines that the external power source has insufficient power to charge the second rechargeable battery and the first rechargeable battery simultaneously, the control circuitry is configured to direct power from the external power source to the non-combustible aerosol provision device to charge the first rechargeable battery only,
wherein if the control circuitry determines that the external power source has sufficient power to charge the second rechargeable battery and the first rechargeable battery simultaneously, the control circuitry is configured to direct power from the external power source to charge the first rechargeable battery and to charge the second rechargeable battery simultaneously,
wherein in a first mode of operation, the plurality of independently controllable aerosol generators are configured to receive electrical power directly from the charging apparatus.

2. The system according to claim 1, wherein, when the external power source is connected to the second electrical connection port and the non-combustible aerosol provision device is connected to the first electrical connection port, the control circuitry prioritises directing electrical power from the external power source to charge the first rechargeable battery until the charge level of the first rechargeable battery reaches a pre-determined charge level where after the control circuitry is configured to direct electrical power from the external power source to charge the second rechargeable battery.

3. The system according to claim 2, wherein the pre-determined charge level is fully charged.

4. The system according to claim 1, wherein, the control circuitry is configured to direct electrical power from the external power source to charge the second rechargeable battery when the external power source is connected to the second electrical connection port and the first electrical connection port is inactive.

5. The system according to claim 1, wherein, the second electrical connection port is also for connecting to a non-power source device and wherein, the control circuitry is configured to direct electrical power from the second rechargeable battery to charge a rechargeable battery of the non-power source device when the non-power source device is connected to the second electrical connection port and the first electrical connection port is inactive.

6. The system according to claim 1, wherein, the second electrical connection port is also for connecting to a non-power source device and wherein, when the first electrical connection port is connected to the non-combustible aerosol provision device and the second electrical connection port is connected to the non-power source device, the control circuitry is configured to prioritise directing electrical power from the second rechargeable battery to charge the first rechargeable battery over directing electrical power from the second rechargeable battery to charge a rechargeable battery of the non-power source device.

7. The system according to claim 6, wherein, when the non-power source device is connected to the second electrical connection port and the non-combustible aerosol provision device is connected to the first electrical connection port, the control circuitry prioritises directing electrical power from the second rechargeable battery to charge the first rechargeable battery until a charge level of the first rechargeable battery reaches a pre-determined charge level where after the control circuitry is configured to direct electrical power from the second rechargeable battery to charge the rechargeable battery of the non-power source device.

8. The system according to claim 1, wherein, the control circuitry is configured to direct electrical power from the second rechargeable battery to charge the first rechargeable battery when the non-combustible aerosol provision device is connected to the first electrical connection port and the second electrical connection port is inactive.

9. The system according to claim 1, wherein, the control circuitry comprises a controller and a plurality of switches controlled by the controller and wherein, the controller configures the plurality of switches in any one of a plurality of different selectable ON/OFF state configurations in order to direct power through the charging apparatus.

10. The system according to claim 9 wherein, in use, the controller configures the plurality of switches in a first one of the plurality of different selectable ON/OFF state configurations in order to direct power from a power supply connected to the second electrical connection port to charge the second rechargeable battery and/or to direct power from the external power source to charge the first rechargeable battery when the non-combustible aerosol provision device is connected to the first electrical connection port.

11. The system according to claim 10, wherein, in use, the controller configures the plurality of switches in a selected second one of the plurality of different selectable ON/OFF state configurations in order to direct power from the second rechargeable battery to charge the first rechargeable battery when the non-combustible aerosol provision device is connected to the first electrical connection port.

12. The system according to claim 1, further comprising one or more indicators arranged to indicate the charge status of the first rechargeable battery.

13. The system according to claim 12, wherein the one or more indicators comprises one or more light emitting diodes.

14. The system according to claim 1, wherein the charging apparatus is a portable carry case for storing the non-combustible aerosol provision device.

15. The system according to claim 1, wherein the plurality of independently controllable aerosol generators comprises at least one inductive heater and at least one resistive heater.
